(19) United States
(12) Patent Application Publication
(10) Pub. No.: US 2014/0136385 A1
(43) Pub. Date: May 15, 2014

(54) SYSTEM AND METHOD FOR CREATING A DOLLAR INDEX BASED ON GLOBAL FOREIGN EXCHANGE TURNOVER

(71) Applicant: DOW JONES & COMPANY, INC., New York, NY (US)

(72) Inventors: Stephen Bernard, New York, NY (US); Vincent Cignarella, Hartsdale, NY (US)

(73) Assignee: DOW JONES & COMPANY, INC., New York, NY (US)

(21) Appl. No.: 13/677,782

(22) Filed: Nov. 15, 2012

(51) Int. Cl. G06Q 40/04

(52) U.S. Cl. CPC G06Q 40/04
USPC 705/37

(57) ABSTRACT

A system and method for creating a dollar index are provided including selecting, from a survey on foreign exchange turnover, data for plural dollar/foreign currency pairs, creating a subset of data from the daily total daily averages of each currency pair and determining the percentage weighting of each currency pair by the total value of the subset, creation of a proportionally weighted dollar index by multiplying the determined weighting of each currency pair with a reported closing price of that currency pair to generate a coefficient for that currency pair and determination of a subsequent current value of the index by multiplying each generated coefficient with a current price for a currency pair.

### TECHNICAL FIELD

The present invention is generally related to creation of a dollar index. More particularly, example embodiments of the present invention are related to systems and methods of creating a dollar index based on global foreign exchange turnover.

### BACKGROUND OF THE INVENTION

Conventional dollar indices are based on equal weighting methods or historical international trade data. One conventional index is the ICE Dollar Index, which is based on international trade data from 1973. It has a formula weighting the dollar against other currencies. The ICE Index was re-weighted once at the introduction of the euro. A link to the ICE Index can be found at https://www.theice.com/productguide/ProductSpec.shtml?specId=194.

Another example is the Dow Jones FXCM Dollar Index, which measures the dollar's value against a fixed basket of currencies that were all equally weighted at the time the index was launched. A link to the Dow Jones FXCM Dollar Index may be found at http://www.djiindexes.com/fxcm/.

The Federal Reserve also has a few different dollar indices. The broad index is a weighted average of the foreign exchange values of the dollar against a large group of U.S. trading partners. The major currencies index is a weighted average of the foreign exchange values of the U.S. dollar against a subset of currencies in the broad index that circulate widely outside the country of issue. There is an “other important trading partners” index, which is a subset of the broad index that includes basically the other currencies that don't get put in the major currencies sub-index. The weightings in the indices are based on U.S. export shares and from U.S. and foreign import shares. The Fed updates its international trade-weighted indices yearly. It provides daily values for the indices, but does not provide any values on an intraday basis. It also, like the ICE Dollar Index, is based on international trade data. Links to the Federal Reserve Dollar Indices may be found at http://www.federalreserve.gov/pubs/bulletin/2005/winter05_index.pdf, http://www.federalreserve.gov/releases/h10/summary/, and http://www.fedfederalreserve.gov/releases/h10/weights/default.htm.

The FTSE Curex FX Index is a tradable index published in real time during the hours of the institutional OTC FX market, from 5 p.m. ET Sunday to 5:00 p.m. ET Friday. The index is a series of indices with the flagship being the FTSE Cürex USD/G8 Index. The G8 index is comprised of eight major currencies: the Euro, British pound, Japanese yen, Canadian dollar, Australian dollar, New Zealand dollar, Swiss Franc and the Chinese Remimbi. The FTSE Curex FX Benchmark Basket Index Series measure the value of equally weighted baskets of currencies against a single base currency. The indices are rebalanced weekly under a transparent rule set. A link to the FTSE Curex FX Index may be found at http://www.curexgroup.com/news.php.

The Dow Jones CME FX$ Index is designed to measure the performance of a basket of currencies traded against the U.S. Dollar. The index is composed of CME-traded futures contracts. It is currency weighted to reflect the general global economic use of the component currencies. Included in the index are four EuroFX, two Japanese yen, two British pound, one Swiss franc, one Canadian dollar and one Australian dollar futures contracts. These component numbers of contracts in the index are fixed; they do not change. The index is calculated daily as the basket value divided by $10,000. Links to the Dow Jones CME FX$ Index may be found at http://www.djiindexes.com/cmefx/, http://www.cmegroup.com/trading/fx/hedgeable-fx-index.html, and http://www.cmegroup.com/trading/fx/g10/dow-jones-cme-fxindex_contract_specifications.html.

JP Morgan Chase publishes a trade-weighted index, called the JP Morgan U.S. Dollar Index. As the title indicates, the index is trade weighted based on international trade data.

While the above indexes attempt to measure the dollar's value, these and other conventional indexes do not truly measure the dollar's value based on current trading volume. For example, the JP Morgan U.S. Dollar Index is based solely on international trade data. As is the case with the ICE U.S. Dollar Index, weightings based on international trade do not provide a good measure of foreign exchange turnover because foreign exchange turnover is not primarily dictated by international trade. Indexes that incorporate only international trade fail to recognize the rapidly growing and large portion of the foreign exchange market that includes speculative trading and other non-commercial related types of trading.

The present invention recognizes this lack and provides a system and method that can provide the marketplace with a more accurate type of measure.

### SUMMARY OF THE INVENTION

As we noted above, the present invention recognizes the problems and deficiencies in the prior art and provides a system and method that can provide the marketplace with a more accurate type of measure of the dollar based on current trading volume. Thus, according to an example embodiment of the present invention, a system and method for creating a dollar index based on global foreign exchange turnover are provided.

In exemplary embodiments, such system and method includes selecting, from a survey on foreign exchange turnover, data for plural dollar/foreign currency pairs, creating a subset of data from the daily total daily averages of each currency pair and determining the percentage weighting of each currency pair by the total value of the subset, and creation of a proportionally weighted dollar index by multiplying the determined weighting of each currency pair with a reported closing price of that currency pair to generate a coefficient for that currency pair.

In exemplary embodiments, determination of a subsequent current value of the index may include multiplying each generated coefficient with a current price for a currency pair.

Also, in exemplary embodiments, the dollar index is periodically reweighted responsive to a subsequent survey on foreign exchange turnover. This may be any reported survey, an example of which is the Bank for International Settlements survey, which is reported every three years. Such reweighing also may occur at any time responsive to survey data (regularly or irregularly) or responsive to a survey reported at any given time interval, e.g., semi-annually, annually, tri-annually, etc.).

In further exemplary embodiments, each of the selected currency pairs account for at least one percent of global foreign exchange market turnover.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views. In the FIGURES:

FIG. 1 is an exemplary system diagram illustrating creation of a dollar index based on global foreign exchange turnover in accordance with exemplary embodiments described herein;

FIG. 2 is a flowchart of an exemplary method for creation of a dollar index based on global foreign exchange turnover in accordance with exemplary embodiments described herein;

FIG. 3 is a continuation of the flowchart of FIG. 2;

FIG. 4 is an exemplary web interface providing report data on a dollar index in accordance with exemplary embodiments described herein;

FIG. 5 is an exemplary system diagram illustrating relationships between data sources, a network and various computing devices in accordance with exemplary embodiments described herein; and

FIG. 6 is an exemplary computer-usable medium in accordance with exemplary embodiments described herein.

### DETAILED DESCRIPTION OF THE INVENTION

Further to the brief description provided above and associated textual detail of each of the FIGURES, the following description provides additional details of example embodiments of the present invention. It should be understood, however, that there is no intent to limit example embodiments to the particular forms and particular details disclosed, but to the contrary, example embodiments are to cover all modifications, equivalents, and alternatives falling within the scope of example embodiments and claims. Like numbers refer to like elements throughout the description of the FIGURES.

It will be understood that, although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the FIGURES. For example, two FIGURES shown in succession, or steps illustrated within any given FIGURE, may in fact be executed substantially concurrently or may sometimes be executed in the reverse order, depending upon the functionality/acts involved.

Hereinafter, exemplary embodiments of the present invention are described in detail.

As we noted above, the present invention recognizes the problems and deficiencies in the prior art and provides a system and method that can provide the marketplace with a more accurate type of measure of the dollar based on current trading volume. Thus, according to an example embodiment of the present invention, a system and method for creating a dollar index based on global foreign exchange turnover are provided.

In exemplary embodiments, such system and method includes selecting, from a survey on foreign exchange turnover, data for plural dollar/foreign currency pairs, creating a subset of data from the daily total daily averages of each currency pair and determining the percentage weighting of each currency pair by the total value of the subset, and creation of a proportionally weighted dollar index by multiplying the determined weighting of each currency pair with a reported closing price of that currency pair to generate a coefficient for that currency pair.

In exemplary embodiments, determination of a subsequent current value of the index may include multiplying each generated coefficient with a current price for a currency pair.

Also, in exemplary embodiments, the dollar index is periodically reweighted responsive to a subsequent survey on foreign exchange turnover. This may be any reported survey, an example of which is the Bank for International Settlements survey, which is reported every three years. Such reweighing also may occur at any time responsive to survey data (regularly or irregularly) or responsive to a survey reported at any given time interval, e.g., semi-annually, annually, tri-annually, etc.).

In further exemplary embodiments, each of the selected currency pairs account for at least one percent of global foreign exchange market turnover.

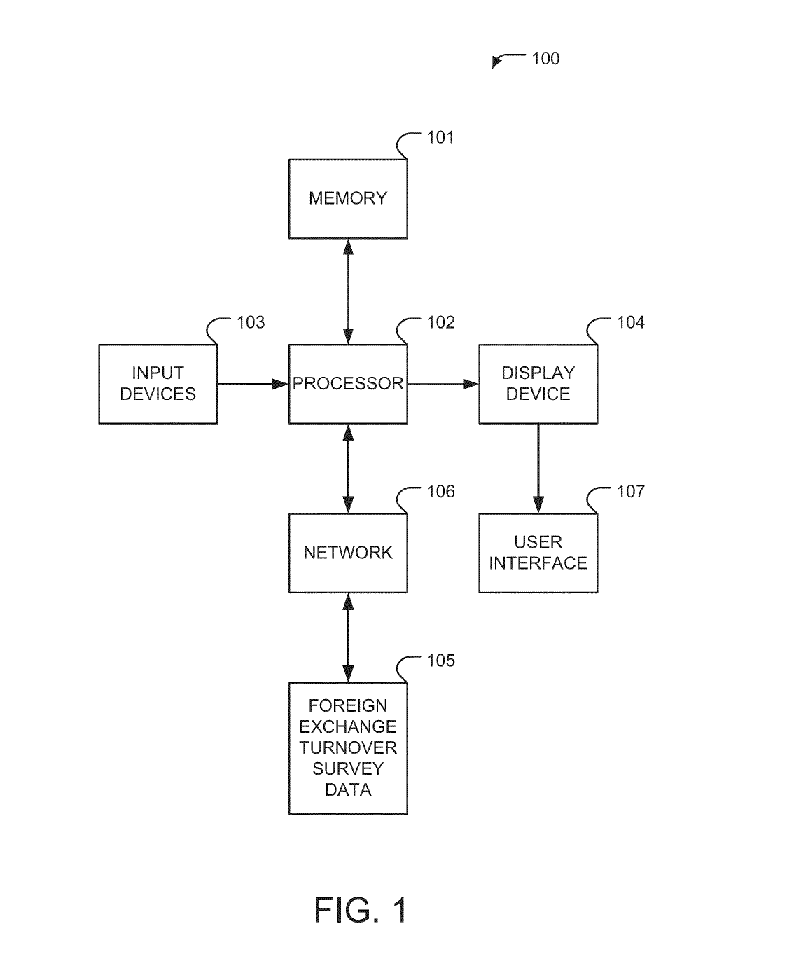

FIG. 1 illustrates a computer apparatus, according to an exemplary embodiment. Portions or the entirety of the methodologies described herein may be executed as instructions in a processor 102 of the computer system 100. The computer system 100 includes memory 101 for storage of instructions and information, input device(s) 103 for computer communication, and display device 104. Thus, the present invention may be implemented, in software, for example, as any suitable computer program on a computer system somewhat similar to computer system 100. For example, a program in accordance with the present invention may be a computer program product causing a computer to execute the example methods described herein.

Generally, example embodiments may include a user interface 107 and application on a computer apparatus, for example, to acquire data from a survey on foreign exchange turnover 105 via a network 106.

In general, a user interface of example embodiments may include icon buttons or other graphical elements for easy manipulation by a user of a computer device (e.g., a user terminal, a server, a mobile device, etc.). The graphical elements may allow control or revision of desired operations.

The user interface 107, or processor 102 operating according to computer code, may also be configured to access or select data for plural dollar/foreign currency pairs, create a subset of data from the daily total daily averages of each currency pair and determining the percentage weighting of each currency pair by the total value of the subset, and create of a proportionally weighted dollar index by multiplying the determined weighting of each currency pair with a reported closing price of that currency pair to generate a coefficient for that currency pair. The user interface 107, or processor 102 operating according to computer code, may also be configured to access already generated dollar index data in accordance with the above and to determine a subsequent current value of the index by multiplying each generated coefficient with a current price for a currency pair.

Also, in exemplary embodiments, user interface 107, or processor 102 operating according to computer code, may be configured to periodically reweight the dollar index responsive to a subsequent survey on foreign exchange turnover. This may be any reported survey, an example of which is the Bank for International Settlements survey, which is reported every three years. Such reweighing also may occur at any time responsive to survey data (regularly or irregularly) or responsive to a survey reported at any given time interval, e.g., semi-annually, annually, tri-annually, etc.).

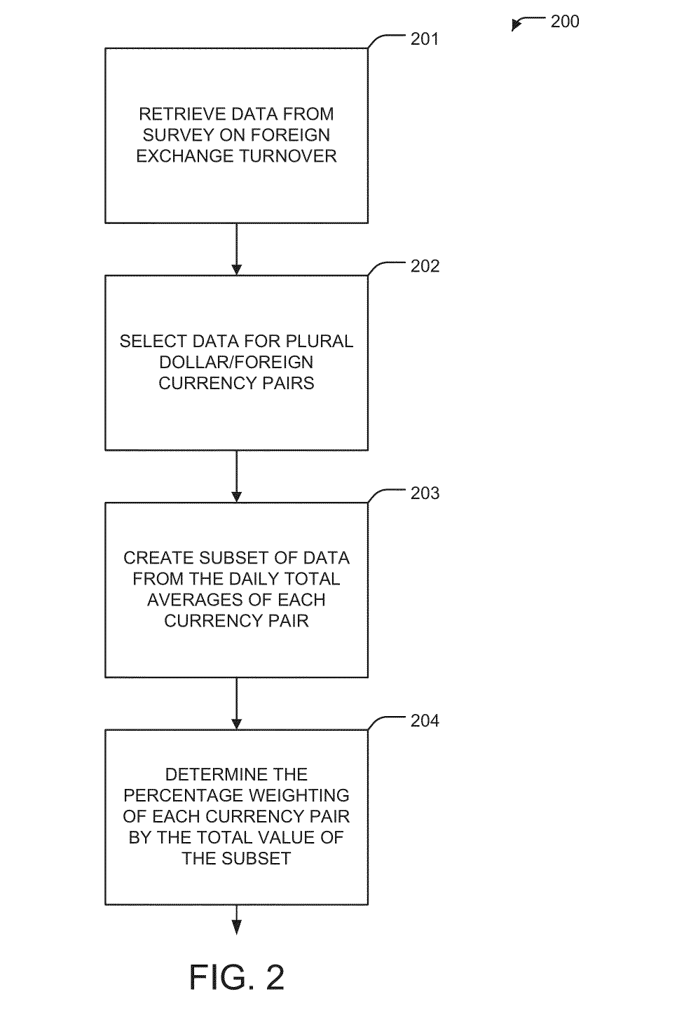

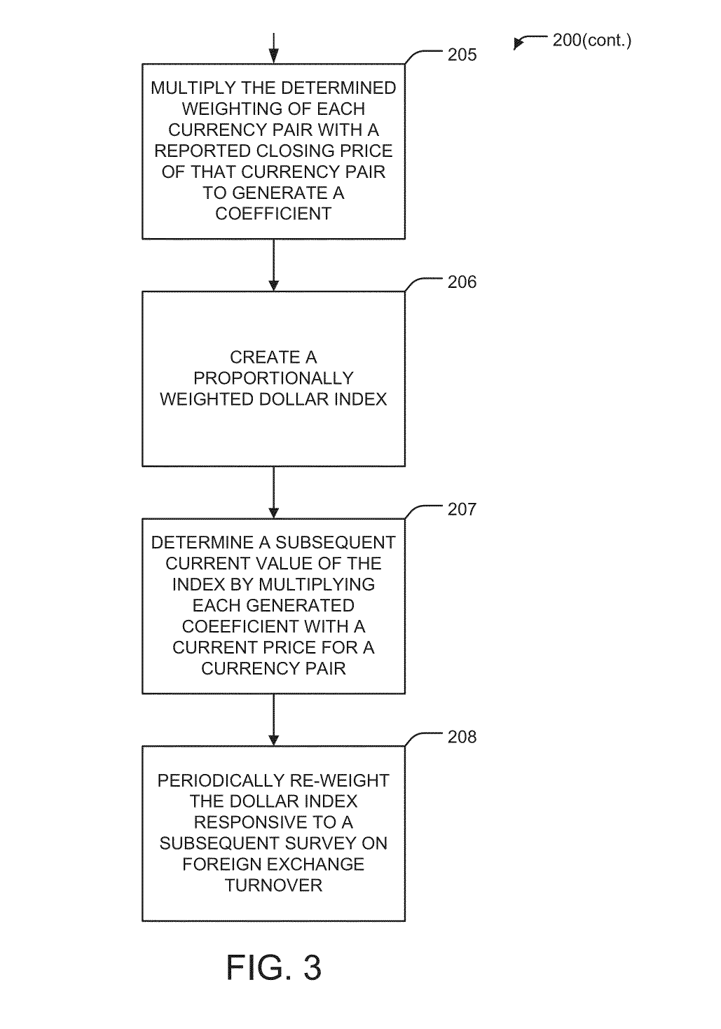

Reference is now made to FIGS. 2 and 3, which illustrate an exemplary method and system flow 200. At block 201, the exemplary system and method retrieve data from a survey on foreign exchange data. As is used herein, the term “survey on foreign exchange data” refers to any reported, published, etc., data on foreign exchange turnover. One such survey is the Bank for International Settlements (BIS) survey, which is considered the most accurate representation of global foreign exchange turnover, as it provides the most accurate trading volume data. Foreign exchange turnover represents any exchange of one currency into another. That turnover volume, which is nearly $4 trillion in aggregate per day, is recorded by the BIS for its triennial survey.

It should be recognized that other survey data may be used, e.g., semi-annual data from global central banks, which would represent trading, but only in certain countries. Additionally, plural surveys may contribute data to the system and method. However, for the purposes of describing exemplary embodiments, the below will describe use of the BIS survey data.

At block 202, the exemplary system and method selects data for plural dollar/foreign currency pairs. In exemplary embodiments, this may be currency pairs that the BIS breaks out as major currency pairs.

In its 2010 triennial survey, that would be table B.6. From there, exemplary systems and methods may determine which dollar currency pairs account for at least 1% of global foreign exchange market turnover. In the 2010 example, there were seven currency pairs; the dollar against the euro, yen, sterling, Australian dollar, Swiss franc, Canadian dollar and Swedish krona.

At block 203, the exemplary system and method creates a subset of data from the daily total averages of each currency pair.

At block 204, the exemplary system and method determines the percentage weighting of each currency pair by the total value of the subset.

At block 205, the exemplary system and method multiplies the determined weighting of each currency pair with a reported closing price of that currency pair to generate a coefficient.

At block 206, the exemplary system and method creates a proportionally weighted dollar index.

At block 207, the exemplary system and method determines a subsequent current value of the index by multiplying each generated coefficient with a current price for a currency pair.

At block 208, the exemplary system and method periodically re-weights the dollar index responsive to a subsequent survey on foreign exchange turnover. In an exemplary embodiment, the index may be re-weighted after the close (5 p.m. Eastern Time) on the first Friday following the release of the BIS survey. In exemplary embodiments, the system may then take the closing value of that Friday and multiply each of the closing currency prices (USD/currency) by a coefficient so at that moment they proportionally represent that percentage of trading they make-up in the subset of the currency pairs used in the index.

It should be recognized that the above re-weighting is merely exemplary, and that such re-weighting may occur responsive to any subsequent data/survey on foreign exchange turnover. For example, weighing may occur responsive to the BIS (or other) survey initially, followed by re-weighting responsive to a different subsequent survey. Any convenient data on foreign exchange turnover may be used for weighing and/or re-weighting. Additionally, such re-weighting may be responsive to periodically provided survey data or may be responsive to irregularly provided data. Examples of regular/periodically provided surveys/data include monthly, quarterly, semi-annually, annually, and tri-annually, among others.

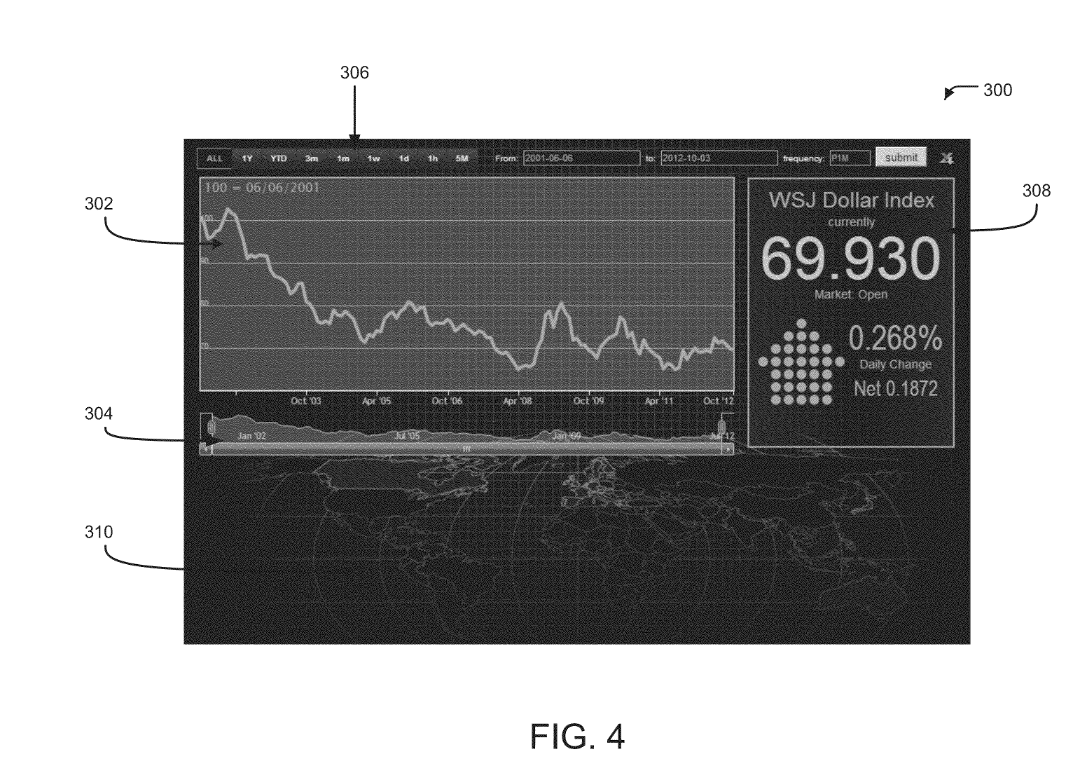

FIG. 4 shows an exemplary dollar index report in accordance with exemplary embodiments disclosed herein. This illustrated index uses the latest global foreign exchange trading volume from the Bank for International Settlements' benchmark triennial FX survey. The illustrated dollar index includes the world's seven most heavily traded currencies, including the Australian dollar and Swedish krona. The index captures the flows of actual foreign exchange trading volume, including from key areas of the market such as hedge funds and proprietary trading. It is configured to be re-weighted regularly to keep up with the ever-changing landscape of the global foreign exchange market.

Referring now to FIG. 4, the exemplary dollar index report is provided as a web interface with index values, shown generally at 302, plotted at from Jun. 6, 2001 to Oct. 3, 2012. An exemplary scrollable bar 304 allows viewable time adjustments. Also, an exemplary upper bar 306 allows time period selections according to year, month, week, etc., or custom input of time periods with specified frequencies. A current dollar index value is indicated in exemplary box 308, along with an indication of daily and net changes. Finally, a global map 310 shows global regions relating to the currency pairs used by the index.

While the above illustrates an exemplary use of the index in a web interface, it should be recognized that the index may presented as a plug-in, integrated feature, importable feature, etc., for any desired investable or other financial product. Accordingly, the present disclosure contemplates exemplary systems, methods and computer programs utilizing the index disclosed herein in any form along with such investable or other financial product, including without limitation, exchange traded funds (ETFs), futures contracts and other products with values relevant to the index.

The index may also be presented as a plug-in, integrated feature, importable feature, etc., for any desired third party platform. Exemplary third platforms may utilize the index values in any desired way, e.g., providing display of data points, facilitating charting of data according to third party engines, etc.

An exemplary system may be provided in accordance with exemplary embodiments described above, including providing a dollar index based on global foreign exchange turnover, comprising: a processor and user interface configured to display a plot of historical dollar index values along with an indication of a current dollar index value, wherein the dollar index comprises processed data from a survey on foreign exchange turnover, including data for plural dollar/foreign currency pairs, wherein a value of the dollar index is determined at a given time by: selecting dollar/foreign currency pairs; creating a subset of data from the daily total daily averages of each currency pair and determining the percentage weighting of each currency pair by the total value of the subset; creating a proportionally weighted dollar index by multiplying the determined weighting of each currency pair with a reported closing price of that currency pair to generate a coefficient for that currency pair; and determining a subsequent current value of the index by multiplying each generated coefficient with a current price for a currency pair.

In one such exemplary system, said dollar index is periodically reweighted following access to a subsequent survey on foreign exchange turnover.

In one such exemplary system, periodic re-weighting occurs regularly.

In another such exemplary system, periodic re-weighting occurs at least semi-annually.

In another such exemplary system, periodic re-weighting occurs at least annually.

In another such exemplary system, periodic reweighting occurs every three years,

In another such exemplary system, plural dollar/foreign currency pairs comprise at least two currency pairs.

In another such exemplary system, plural dollar/foreign currency pairs comprise at least three currency pairs.

In another such exemplary system, plural dollar/foreign currency pairs comprise at least four currency pairs.

In another such exemplary system, plural dollar/foreign currency pairs comprise at least five currency pairs.

In another such exemplary system, plural dollar/foreign currency pairs comprise at least six currency pairs.

In another such exemplary system, plural dollar/foreign currency pairs comprise at least seven currency pairs.

In another such exemplary system, dollar/foreign currency pairs include the dollar against the euro, yen, sterling, Australian dollar, Swiss franc, Canadian dollar and Swedish krona.

In another such exemplary system, the system further comprises providing selectable or customizable time plot periods.

In another such exemplary system, the system further comprises providing selectable or customizable plot time frequencies.

In another such exemplary system, the system further comprises providing a global map having an indication thereon of regions relating to currency pairs used by the index.

In another such exemplary system, the index is provided as a plug-in, integrated feature, or importable feature for a third party platform.

In another such exemplary system, the third party platform is configured to provide display of data points or facilitate charting of data according to third party engines.

### Example 1

The following provides an example based upon the 2010 BIS triennial survey:

On Dec. 3, 2010, the index closed at 70.1471. For purposes of this example, the example takes the weightings of the seven currencies that would constitute the index and proportionally weights them based on what percentage of trading volume they represented among the group.

2010 Weighting

| Currency Pair | Amount | Weighting | |
|---|---|---|---|
| USD/EUR | 1,101 | 41.190% | 28.89338 |
| USD/JPY | 568 | 21.250% | 14.90594 |
| USD/GBP | 360 | 13.468% | 9.447426 |
| USD/AUD | 249 | 9.315% | 6.53447 |
| USD/CHF | 168 | 6.285% | 4.408799 |
| USD/CAD | 182 | 6.809% | 4.776199 |
| USD/SEK | 45 | 1.684% | 1.180928 |
| Subtotal | 2,673 | 100.000% | 70.14714 |

According to the above, for example, USD/EUR would have to equal 28.89338. The closing price of USD/EUR may then be ascertained, which is just the inversion of the traditional EUR/USD quote (1/(EUR/USD)), to determine a coefficient. This can be repeated for each currency pair, as seen below. All currency pairs may be constructed as USD/currency so that it represents the gains or losses in the dollar (some typical currency pairs as they are quoted in the market must be inverted, like EUR/USD).

| Currency Pair | Weighting | Closing Price | Coefficient |
|---|---|---|---|
| USD/EUR | 28.893378/ | 0.745434215 = | 38.76046607 |
| USD/JPY | 14.905939/ | 82.53500 = | 0.180601426 |
| USD/GBP | 9.4474259/ | 0.633834062 = | 14.90520388 |
| USD/AUD | 6.5344696/ | 1.006846557 = | 6.490035204 |
| USD/CHF | 4.4087988/ | 0.97375 = | 4.527649565 |
| USD/CAD | 4.7761987/ | 1.00415 = | 4.756459355 |
| USD/SEK | 1.1809282/ | 6.7965 = | 0.173755351 |

The coefficient may then used in the formula to track the index in real time until the index is re-weighted following the next release of the BIS triennial report.

The sum of multiplying each coefficient by the current price of the currency pair may be used to determine the value of the current value of the index.

In the 2010 example, the formula would look like the following:

((1/(EUR/USD))*38.76046607)+((USD/JPY)*0.180601426)+

((1/(GBP/USD))*14.90520388)+((1/(AUD/USD))*6.490035204)+

((USD/CHF)*4.527649565)+((USD/CAD)*4.756459355)+((USD/SEK)*0.173755351)=An

Example of the Present Dollar Index.

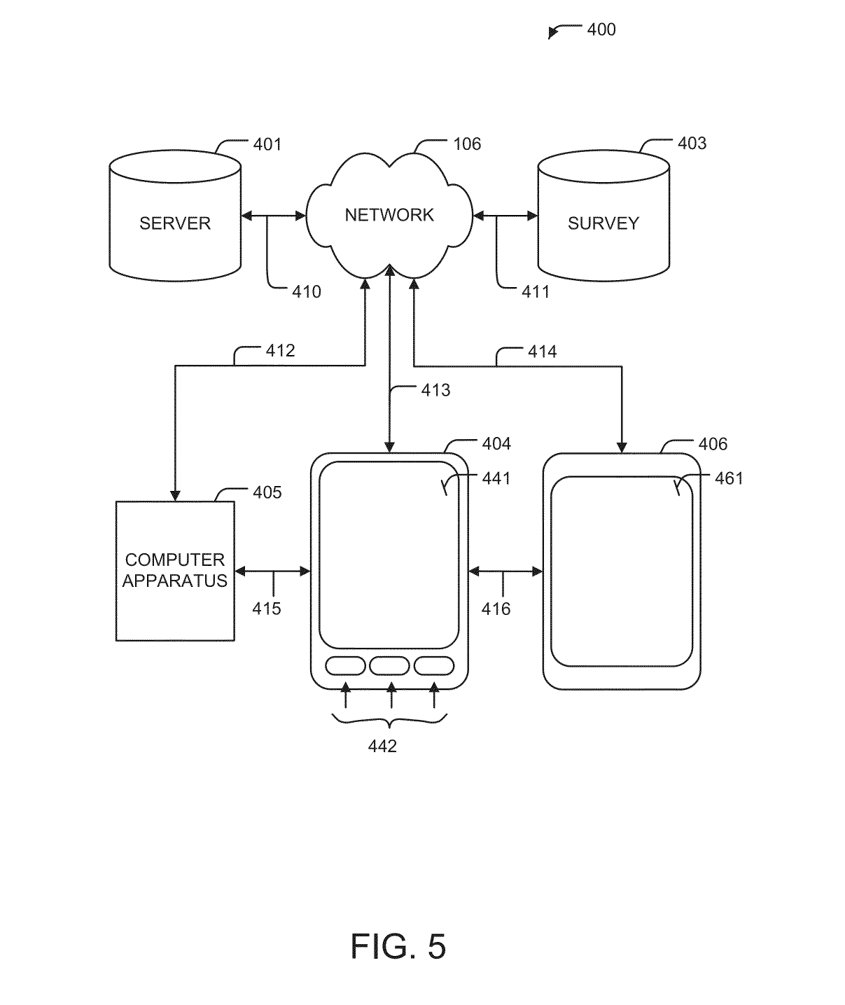

FIG. 5 is an exemplary system for creating a dollar index based on global foreign exchange turnover. The system 400 may include a server 401. The server 401 may include a plurality of information, including but not limited to, global foreign exchange data, including survey data, data relating to dollar/foreign currency pairs, daily total averages of currency pairs, closing prices of currency pairs, weights, coefficients, historical global foreign exchange data, projected data, computer executable code, or any other suitable information.

The exemplary system 400 further includes a source of data 403 (e.g., a publisher or distributer of survey data) in communication with the server 401 over a network 106. It is noted that although illustrated as separate, the source 403 may include a server substantially similar to server 401. The source may be a data service provider, for example, a cellular service provider, a business information provider, or any other suitable provider or repository. The source 403 may also be an application server providing applications and/or computer executable code implementing any of the interfaces/methodologies described herein. The source 403 may present a plurality of application defaults, choices, set-ups, and/or configurations such that a device may receive and process the application accordingly. The source 403 may present any application on a user interface or web-browser of a device for relatively easy selection by a user of the device. The user interface or web-page rendered for application selection may be in the form of an application store and/or application marketplace.

Alternately, the server 401 or local computer apparatus, e.g., 404, 405 and/or 406, may produce the user interface and control connectivity to the source 403 or the server 401. Also, the server 401 or one or more of the local computer apparatus 404, 405 and 406 may be configured to periodically access the source 403 and cache data relevant to data used to the dollar index.

The network 106 may be any suitable network, including the Internet, wide area network, and/or a local network. The server 401 and the source 403 may be in communication with the network 106 over communication channels 410, 411. The communication channels 410, 411 may be any suitable communication channels including wireless, satellite, wired, or otherwise.

The system 400 further includes computer apparatus 405 in communication with the network 106, over communication channel 412. The computer apparatus 405 may be any suitable computer apparatus including a personal computer (fixed location), a laptop or portable computer, a personal digital assistant, a cellular telephone, a portable tablet computer, a portable audio player, or otherwise. For example, the system 400 may include computer apparatuses 404 and 406, which are embodied as a portable cellular telephone and a tablet, respectively. The apparatuses 404 and 406 may include display means 441, 461, and/or buttons/controls 442. The controls 442 may operate independently or in combination with any of the controls noted above.

Further, the apparatuses 404, 405, and 406 may be in communication with each other over communication channels 415, 416 (for example, wired, wireless, Bluetooth channels, etc); and may further be in communication with the network 106 over communication channels 412, 413, and 414.

Therefore, the apparatuses 404, 405, and 406 may all be in communication with one or both of the server 401 and the source 403, as well as each other. Each of the apparatuses may be in severable communication with the network 106 and each other, such that the apparatuses 404, 405, and 406 may be operated without constant communication with the network 106 (e.g., using data connection controls of an interface). For example, if there is no data availability or if a user directs an apparatus to work offline, the data used by any of the apparatuses 404, 405, and 406 may be based on stored or cached information/parameters. It follows that each of the apparatuses 404, 405, and 406 may be configured to perform the methodologies described above; thereby creating a dollar index based on global foreign exchange turnover.

Furthermore, using any of the illustrated communication mediums, the apparatuses 404, 405, and 406 may manipulate, share, transmit, and/or receive different data previously or currently produced at any one of the illustrated elements of the system 400. For example, data may be available on the server 401 and/or the source 403. Moreover, users of any of the devices 404, 405, and 406 may independently manipulate, transmit, etc., data, e.g., to separately determine a current value of the index at a given time. Further, an interface providing dollar index values and information, such as is illustrated in FIG. 4, may be provided by the server 401, an Internet site (not shown), or locally on any of the devices 404, 405 and 406 via appropriate software code.

Additionally and as described above, example embodiments of the invention may be embodied in the form of computer-implemented processes and apparatuses for practicing those processes. Therefore, according to an example embodiment, the methodologies described hereinbefore may be implemented by a computer system or apparatus. A computer system or apparatus may be somewhat similar to the mobile devices and computer apparatuses described above, which may include elements as described below.

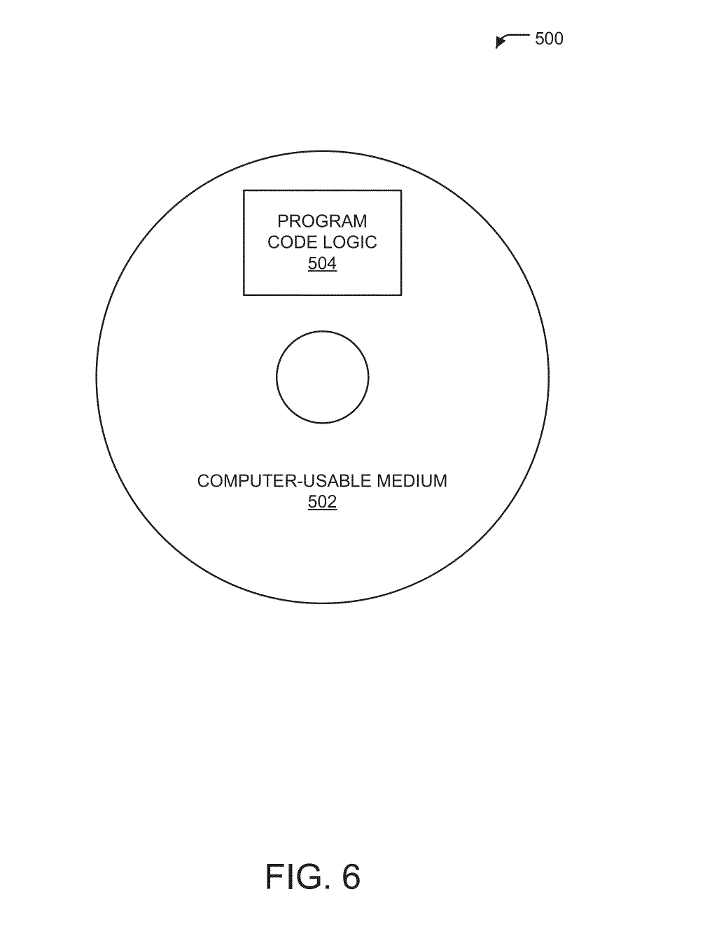

Therefore, embodiments can be embodied in the form of computer-implemented processes and apparatuses for practicing those processes on a computer program product. Embodiments include the computer program product 500 as depicted in FIG. 6 on a computer usable medium 502 with computer program code logic 504 containing instructions embodied in tangible media as an article of manufacture. Exemplary articles of manufacture for computer usable medium 502 may include floppy diskettes, CD-ROMs, hard drives, universal serial bus (USB) flash drives, or any other computer-readable storage medium, wherein, when the computer program code logic 504 is loaded into and executed by a computer, the computer becomes an apparatus for practicing the invention. Embodiments include computer program code logic 504, for example, whether stored in a storage medium, loaded into and/or executed by a computer, or transmitted over some transmission medium, such as over electrical wiring or cabling, through fiber optics, or via electromagnetic radiation, wherein, when the computer program code logic 504 is loaded into and executed by a computer, the computer becomes an apparatus for practicing the invention. When implemented on a general-purpose microprocessor, the computer program code logic 504 segments configure the microprocessor to create specific logic circuits.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

As described above, features of example embodiments include creating a dollar index based on global foreign exchange turnover, and other unique features not found in the conventional art.

Exemplary embodiments of the presently described dollar index provide an index that is proportionally weighted on global foreign exchange trading volume, e.g., as reported by the Bank for International Settlements. Other dollar indices are based on equal weighting methods or historical international trade data. In exemplary embodiments, the present dollar index may be re-weighted every time an updated foreign exchange survey is available, e.g., the BIS publishes an updated triennial global foreign exchange survey. Various exemplary features, e.g., the described weightings, methodology and construct of the presently described dollar index make it unique from others in the marketplace. The presently described dollar index captures global foreign exchange turnover, thus making it a truer representation of the dollar's value because the dollar's value is based solely on how it moves against other currencies.

Thus, exemplary embodiments of the presently described dollar index provides the best, most accurate picture of the dollar's value against a broad basket of highly liquid currencies. In exemplary embodiments, the index accurately represents two-thirds of all global foreign exchange market turnover. The FX market is a nearly $4 trillion a day market, the world's largest. Thus, presently described exemplary embodiments provide the financial industry the best view of one of the most important assets in the world.

It should be emphasized that the above-described embodiments of the present invention, particularly, any detailed discussion of particular examples, are merely possible examples of implementations, and are set forth for a clear understanding of the principles of the invention. Many variations and modifications may be made to the above-described embodiment(s) of the invention without departing from the spirit and scope of the invention. For example, the present disclosure should not be limited to the number or selection of any particular currency pairs. Accordingly, various different indexes may be generated as desired in accordance with exemplary embodiments disclosed herein. All such modifications and variations are intended to be included herein within the scope of this disclosure and the present invention and protected by the following claims.

1. A method for creating a dollar index based on global foreign exchange turnover, comprising:
selecting, from a survey on foreign exchange turnover, data for plural dollar/foreign currency pairs;
creating a subset of data from the daily total daily averages of each currency pair and determining the percentage weighting of each currency pair by the total value of the subset;
create a proportionally weighted dollar index by multiplying the determined weighting of each currency pair with a reported closing price of that currency pair to generate a coefficient for that currency pair;
determining a subsequent current value of the index by multiplying each generated coefficient with a current price for a currency pair; and
periodically reweighting the dollar index responsive to a subsequent survey on foreign exchange turnover.

2. A method in accordance with claim 1, wherein the selected currency pairs are selected as being representative of major liquid currencies.

3. A method in accordance with claim 1, wherein each of the selected currency pairs account for at least one percent of global foreign exchange market turnover.

4. A method in accordance with claim 1, wherein said periodic re-weighting occurs regularly.

5. A method in accordance with claim 1, wherein said periodic re-weighting occurs at least semi-annually.

6. A method in accordance with claim 5, wherein said periodic reweighting occurs every three years.

7. A method in accordance with claim 1, wherein said plural dollar/foreign currency pairs comprise at least two currency pairs.

8. A method in accordance with claim 7, wherein said plural dollar/foreign currency pairs comprise at least three currency pairs.

9. A method in accordance with claim 8, wherein said plural dollar/foreign currency pairs comprise at least seven currency pairs.

10. A method in accordance with claim 9, wherein said dollar/foreign currency pairs include the dollar against the euro, yen, sterling, Australian dollar, Swiss franc, Canadian dollar and Swedish krona.

11. A method in accordance with claim 1, further comprising displaying, on a user interface, a plot of historical dollar index values, along with an indication of a current dollar index value.

12. A method in accordance with claim 11, further comprising providing selectable or customizable time plot periods.

13. A method in accordance with claim 12, further comprising providing selectable or customizable plot time frequencies.

14. A method in accordance with claim 13, further comprising providing a global map having an indication thereon of regions relating to currency pairs used by the index.

15. A method in accordance with claim 1, further comprising providing said index as plug-in, integrated feature or importable feature for an investable or other financial product.

16. A method in accordance with claim 15, wherein said product is an exchange traded fund or future contract.

17. A method in accordance with claim 1, further comprising providing said index as a plug-in, integrated feature, or importable feature for a third party platform.

18. A system in accordance with claim 17, wherein said third party platform is configured to provide display of data points or facilitate charting of data according to third party engines.

19. A system for creating a dollar index based on global foreign exchange turnover, comprising:
a processor and interface configured to access data from a survey on foreign exchange turnover, including data for plural dollar/foreign currency pairs, wherein said processor or interface is configured to:
select dollar/foreign currency pairs;
create a subset of data from the daily total daily averages of each currency pair and determining the percentage weighting of each currency pair by the total value of the subset;
create a proportionally weighted dollar index by multiplying the determined weighting of each currency pair with a reported closing price of that currency pair to generate a coefficient for that currency pair;
determine a subsequent current value of the index by multiplying each generated coefficient with a current price for a currency pair; and
periodically access a subsequent survey on foreign exchange turnover and reweight the dollar index responsive to said subsequent survey on foreign exchange turnover.

20. A system in accordance with claim 19, wherein the processor or interface is configured such that each of the selected currency pairs are selected as being representative of major liquid currencies.

21. A system in accordance with claim 19, wherein the processor or interface is configured such that each of the selected currency pairs account for at least one percent of global foreign exchange market turnover.

22. A system in accordance with claim 19, wherein said periodic re-weighting occurs regularly.

23. A system in accordance with claim 22, wherein said periodic re-weighting occurs at least semi-annually.

24. A system in accordance with claim 23, wherein said periodic reweighting occurs every three years.

25. A system in accordance with claim 19, wherein said plural dollar/foreign currency pairs comprise at least two currency pairs.

26. A system in accordance with claim 25, wherein said plural dollar/foreign currency pairs comprise at least three currency pairs.

27. A system in accordance with claim 26, wherein said plural dollar/foreign currency pairs comprise at least seven currency pairs.

28. A system in accordance with claim 19, wherein said index is provided as plug-in, integrated feature or importable feature for an investable or other financial product.

29. A system in accordance with claim 28, wherein said product is an exchange traded fund or future contract.

30. A system in accordance with claim 19, wherein said index is provided as a plug-in, integrated feature, or importable feature for a third party platform.

31. A system in accordance with claim 30, wherein said third party platform is configured to provide display of data points or facilitate charting of data according to third party engines.

32. A system for providing a dollar index based on global foreign exchange turnover, comprising:
a processor and user interface configured to display a plot of historical dollar index values along with an indication of a current dollar index value, wherein the dollar index comprises processed data from a survey on foreign exchange turnover, including data for plural dollar/foreign currency pairs, wherein a value of the dollar index is determined at a given time by:
selecting dollar/foreign currency pairs;
creating a subset of data from the daily total daily averages of each currency pair and determining the percentage weighting of each currency pair by the total value of the subset;
creating a proportionally weighted dollar index by multiplying the determined weighting of each currency pair with a reported closing price of that currency pair to generate a coefficient for that currency pair; and
determining a subsequent current value of the index by multiplying each generated coefficient with a current price for a currency pair.

33. A system in accordance with claim 15, wherein said dollar index is periodically reweighted following access to a subsequent survey on foreign exchange turnover.
